(19) United States
(12) Patent Application Publication
(10) Pub. No.: US 2013/0096701 A1
(43) Pub. Date: Apr. 18, 2013

(54) METHOD FOR CONTROLLING AN OPERATING TABLE WITH A PORTABLE DEVICE

(71) Applicant: MERIVAARA OY, Lahti (FI)

(72) Inventors: Juha SUORAJAERVI, Nastola (FI); Arto KOSKI-LAULAJA, Hollola (FI)

(73) Assignee: MERIVAARA OY, Lahti (FI)

(21) Appl. No.: 13/651,117

(22) Filed: Oct. 12, 2012

(30) Foreign Application Priority Data
Oct. 12, 2011 (FI) 20116005

(51) Int. Cl. G05B 15/02

(52) U.S. Cl. 700/83

(57) ABSTRACT

According to one exemplary embodiment, the application relates to a method for controlling an operating table with a portable device by receiving an operating table activation command by way of the portable device's touch screen and transmitting an adjustment command consistent with the activation command wirelessly to an operating table for controlling the same in accordance with the adjustment command.

### PRIORITY CLAIM

This application claims the benefit of priority based on Finland Patent Application No. 20116005 filed on Oct. 12, 2011, which is hereby incorporated by reference in its entirety.

### TECHNICAL FIELD

The application relates generally to a method for controlling an operating table with a portable device.

### BACKGROUND

Operating tables are used in operating rooms for placing patients in such a way that, regarding each patient and procedure, the patient can be placed by means of the operating table firmly in such a position that enables the procedure to be conducted in an optimum manner. Traditionally, operating tables have been adjusted to a desired orientation by means of the action buttons of control panels integrally mounted thereon, as well as by means of remote controllers provided with action buttons.

One example of a remote controller intended for controlling an operating table is the wireless remote controller described in patent application US 2009/0126115 A1, comprising action buttons for generating control commands, as well as a liquid crystal display for presenting the remote controller-issued commands to the operating table.

A problem with stationary control panels and remote controllers provided with a plurality of action buttons has been their clumsy workability with latex gloves to be worn in operating rooms for hygienic reasons. This has resulted in faulty adjustment commands such as double clicking and simultaneous pressing of several buttons, which have hindered or delayed a procedure to be conducted on a patient or even caused harm to a patient.

Another problem with stationary action panels and remote controllers has been the soiling caused by operating room conditions, whereby the often fluidic soil has been easily able to work its way inside a remote controller or control panel by way of a junction between the action buttons and the surface of the remote controller or control panel and to inflict mechanical or electrical disruptions in their service.

In addition, the plurality of action buttons has been a source of trouble in terms of cleaning control panels and remote controllers as the cleaning of a keyboard is an awkward and slow process because of the multiplicity of buttons with grime clinging easily to the control panel or remote controller and causing service disruptions and the propagation of pathogens along with grime.

### SUMMARY

It is one objective of the invention to facilitate the control of an operating table present in a surgical operating theatre while wearing protective surgical gloves, to improve the control of an operating table in terms of its working reliability, as well as to improve the hygiene of operating rooms.

The one objective of the invention is achieved by a method of claim 1, a device of claim 8, a system of claim 9, and by a computer program of claim 10.

A method according to one embodiment for controlling an operating table with a portable device comprises receiving an operating table activation command via a touch screen of a portable device and transmitting wirelessly an adjustment command consistent with the activation command to the operating table for controlling the same in accordance with the adjustment command.

The term “operating table” refers for example to an adjustable support used in health care service, wherein the surgical patient can be placed in a position beneficial from the procedural standpoint by means of table adjustments.

The term “portable device” refers for example to a hand-held and freely movable device, which can be for example a remote controller, a telecontrol device, a mobile phone, a smart phone, a laptop, and a tablet computer.

The term “wirelessness” refers for example to the use of radio frequency (RF) and/or infrared technology (IR) for example for communication between a portable device and a controlled apparatus, the portable device being intended for controlling an operating table and/or its lamps and/or cameras intended for imaging the same.

A portable device according to one embodiment for controlling an operating table has at least one processor and at least one memory comprising a computer program code. The at least one memory and the computer program code are adapted, jointly with the at least one processor, to enable the portable device to at least receive an operating table activation command via a touch screen of the device and to transmit wirelessly an adjustment command consistent with the activation command to the operating table for controlling the same in accordance with the adjustment command.

A system according to one embodiment for controlling an operating table comprises an operating table and a portable device intended for controlling the operating table, which has at least one processor and at least one memory comprising a computer program code. The at least one memory and the computer program code of the portable device are adapted, jointly with the at least one processor, to enable the portable device to at least receive an operating table activation command via a touch screen of the device and to transmit wirelessly an adjustment command consistent with the activation command to the operating table for controlling the same in accordance with the adjustment command.

A computer program according to one embodiment for controlling an operating table with a portable device comprises executing the computer program with a processor and having a reception code for receiving an operating table activation code via a touch screen of a portable device and a transmission code for transmitting an adjustment command consistent with the activation command wirelessly to the operating table for controlling the same in accordance with the adjustment command.

Other embodiments are presented in the dependent claims.

It is further by means of the method and device according to the embodiments that instructions can be given visually to a user of the portable device and performed adjustments can be displayed, which enables a clear presentation of the operating table's current status to the user of the portable device.

In addition, the method and device according to the embodiments ensure by optical communication that the user of the portable device is capable of conducting solely the adjustment of his/her preference for an operating table, lamps and/or cameras, without having to be concerned about adjusting a wrong unit. This results in reducing the number of control commands sent to wrong units and, as a consequence, the possible hazards and pains inflicted on patients.

### BRIEF DESCRIPTION OF THE FIGURES

Exemplary embodiments of the invention will be more specifically presented in the detailed description of the figures with reference to the accompanying figures, in which

FIG. 1 shows a flow chart for a method implemented by a portable device intended for controlling an operating table,

FIGS. 2a-2g show screenshots from a control device display,

FIGS. 3a-3b show functional units for and the appearance of a device implementing the method, and

FIG. 4 shows a system for controlling an operating table and a lamp/camera unit.

### DETAILED DESCRIPTION OF THE FIGURES

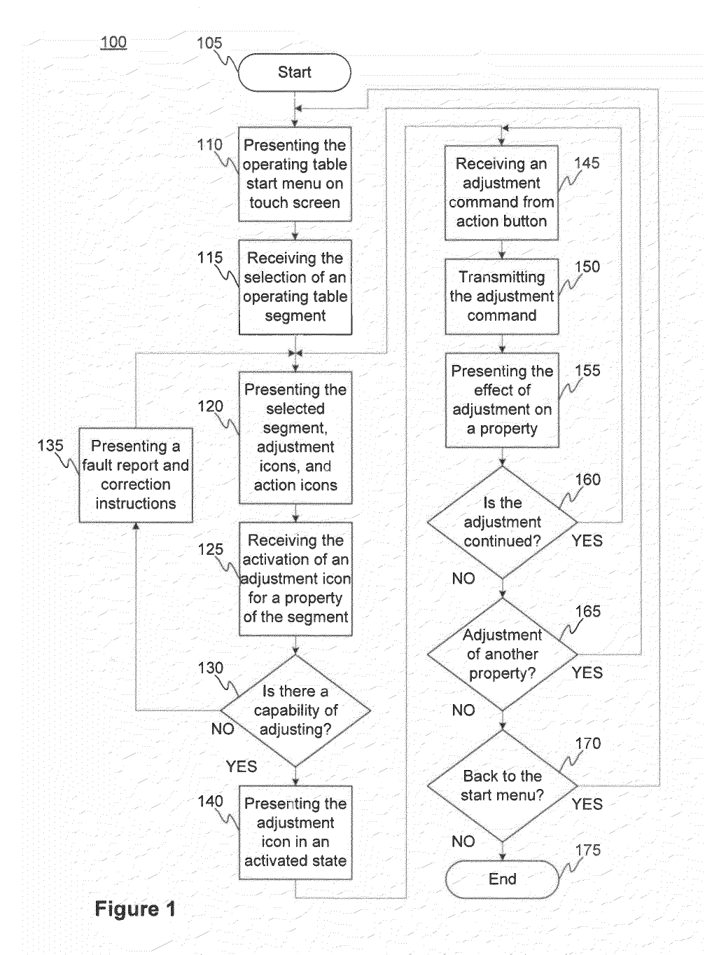

FIG. 1 shows a method 100 for controlling an operating table included in an operating room unit with a portable device, i.e. with a wireless remote controller, which is capable of communicating with the operating table either over an RF and/or IR link. The operating room unit constitutes an assembly, including at least one or more of the following: an actual operating table, at least one lamp, at least one camera, and accessories associated with the above.

In a method according to one embodiment, as set forth in any of the preceding embodiments, the operating table is included in an operating room unit which may further comprise at least one of the following: at least one lighting unit for the operating table and at least one monitor for the operating table.

A start phase 105 comprises activating the remote controller from a power switch intended for its start-up and the operating table of an operating room unit from a power switch found in its own control panel. In connection with initialization routines following the activation, the remote controller may update its software, install new programs, and/or delete outdated unnecessary updates and/or programs from the remote controller for maintaining its memory capacity.

Before a remote controller can be enabled to control some specific operating table, the remote controller and the operating table must be paired with each other. The pairing takes place by bringing the remote controller to the proximity of an operating table and by activating a pairing button of the operating table, whereby the operating table transmits over an RF link a pairing request and the operating table's pairing button, i.e. a SYNC button, has its led light blinking for example for 30 seconds in anticipation of a response from the remote controller. When the operating table's request is answered by pressing a pairing icon, i.e. a SYNC icon, displayed on the remote controller's touch screen, the remote controller works out over an RF link a response to the operating table. For example within five seconds of transmitting the response, the user must further select the apparatus to be controlled by way of the touch screen, an actual operating table or possibly a lighting unit provided with at least one camera and included in the operating room unit. When the apparatus-remote controller pair to be controlled has been established, the touch screen has its pairing button blinking as a sign of the link having been established. On the remote controller's display is presented a message about successful pairing and the RF code and/or IR code specific for the operating table and/or lighting unit is stored in the remote controller's memory. After the pairing, the remote controller can only be used for controlling just this particular operating table, lamp or camera, and the pair remains valid regardless of power-off periods until a new pairing is set up with some other operating table.

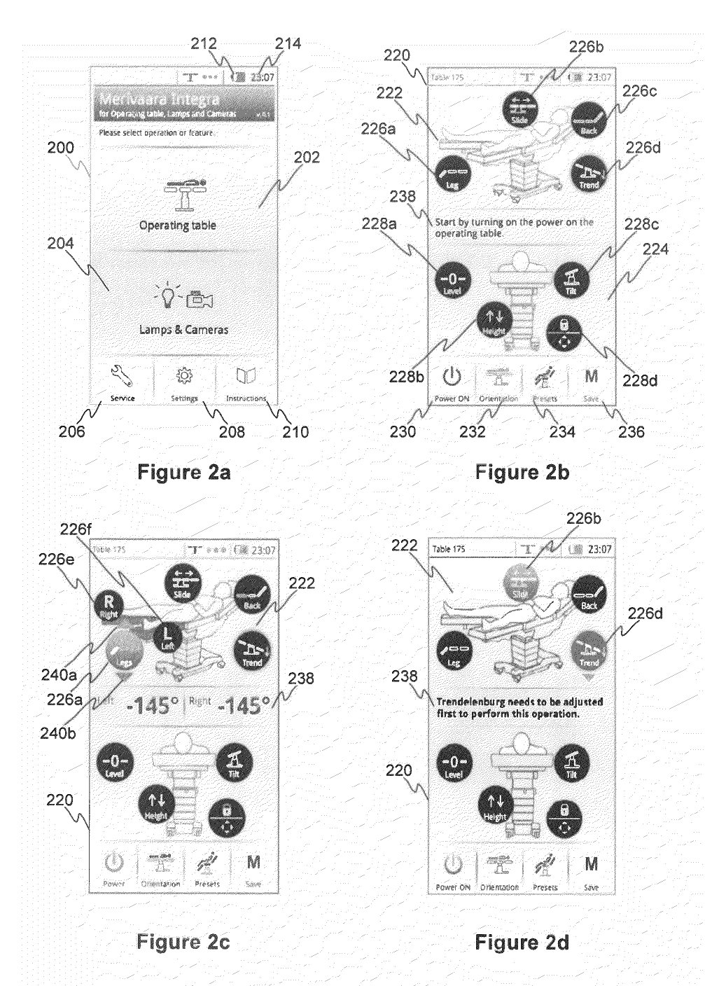

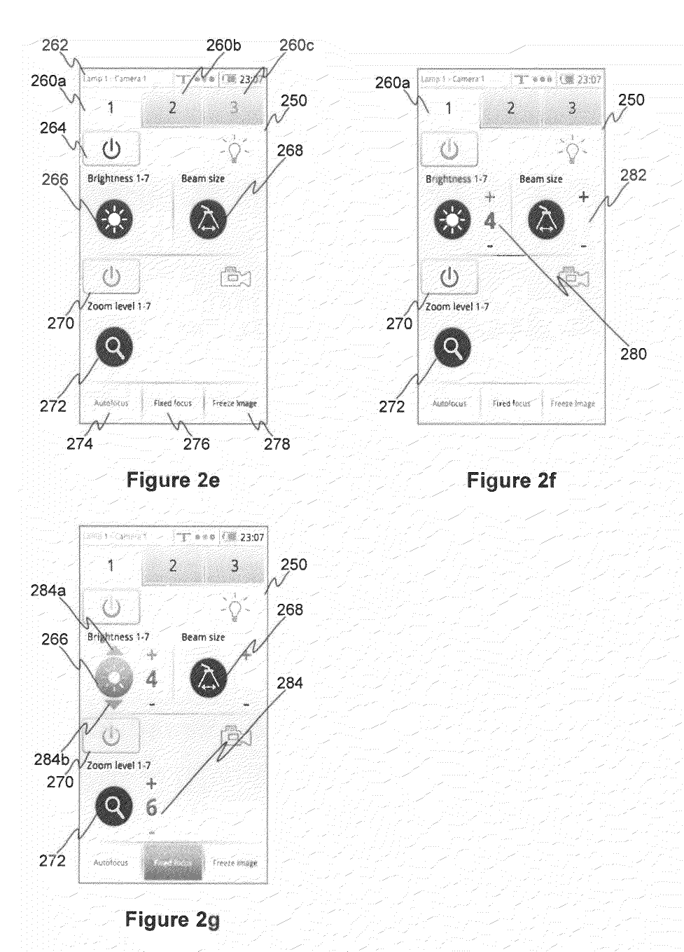

In phase 110, on the remote controller's touch screen is displayed a start menu 200 as shown in FIG. 2a for the user interface of an operating table, which enables a selection of either an operating table icon 202 intended for controlling operating table segments or an icon 204 for lamps and cameras, or any of the icons service 206, settings 208, and instructions 210 indicating auxiliary features. On the start menu 200 is further shown a battery state of charge 212 and a clock time 214.

When the user wishes to adjust a position of the operating table and touches the icon 202 indicating an operating table, the remote controller receives in phase 115 a selection for the operating table control, as a consequence of which the touch screen displays in phase 120 an operating table tab page 220 as shown in FIG. 2b with a graphical view of the operating table from two different perspectives 222, 224. Related to the upper side view 222 of an operating table, in which the operating table is shown obliquely from the foot end, as in the present case, or obliquely from the head end, there are operating table adjustment icons for a leg segment (Leg) 226a, a table top position (Slide) 226b, a back support (Back) 226c, and for a position of the table top's head segment with respect to a middle segment of the table (Trend, Trendelenburg) 226d. In the lower end view 224 of an operating table, the operating table is shown in a view directly from the head end, as in the present case, or directly from the foot end. Related to the lower end view 224 there are adjustment icons for a level (Level) 228a, which drives all segments of the operating table to a horizontal level, for a height (Height) 228b, which drives the operating table elevation motor up and down, for a lateral inclination (Tilt) 228c, and for locking/use of a fifth wheel 228d. In addition, on the tab page 220 are shown auxiliary function keys for switching the power on/off 230, for a viewing direction 232, for stored operating table settings 234, and for storing the settings 236. Furthermore, between the perspectives 222, 224, the tab page 220 features an information space 238 for guiding the user. In FIG. 2b, for example, the user is requested to turn on the operating table power.

A method according to one embodiment, as set forth in any of the preceding embodiments, further comprises presenting from at least one perspective an operating table top intended to be graphically controlled with a touch screen, as well as at least one adjustment icon and/or action icon for a property of the operating table top.

In case the operating table is still in a power-off state or in a sleep mode, the user may activate it at this stage by pressing a power icon 230 displayed on the touch screen, whereby the remote controller transmits a power turn-on command to the operating table by way of an RF link and changes the appearance or coloring of the power icon 230 to indicate that the operating table has its power on. Respectively, resetting the operating table to a sleep mode or turning off its power is carried out by pressing the on-state power icon 230. The touch screen proceeds into a sleep mode unless it is used within some predefined period, and it is reactivated from the remote controller's power switch.

Once the operating table power has been turned on and/or the operating table has been awakened, the user may begin its control by means of the adjustment icons 226a, 226, 226c, 226d, 228a, 228b, 228c, 228d present on the touch screen. In case the user wishes to adjust for example the position of the operating table's leg segment, he/she activates by finger pressing the leg segment adjustment icon 226a on the touch screen in phase 125, whereby the remote controller receives an activation command by way of the touch screen.

At this point, it is possible that the remote controller first ensures by way of an IR link that the remote controller and the operating table are in a common mode, i.e. are in optical communication, and does not transmit, until after an IR check, an activation command by way of an RF link to the operating table, whereby it is aware of the next command being applied to the leg segment. Alternatively, the target of adjustment is not indicated to the operating table until in connection with the transmission of an actual adjustment command.

If the leg segment adjustment has not been prevented, there are presented in phase 140 the adjustment icon 226a as activated as a consequence of activation, for example by changing its appearance or coloring as shown in FIG. 2c, as well as adjustment instructions 240c, 240b for action buttons, for example green and red/orange action buttons, present in the remote controller and intended for the actual leg segment adjustment, and current leg segment settings in the information space 238. In addition, the leg segment to be adjusted in response to activation can be pointed out to the user for example by darkening it at least in the side view 222. In the event that the leg segment is made in two parts and enables an adjustment of right and left legs separately, as shown in FIG. 2c, in connection with the activated adjustment icon 226a are presented adjustment icons 226e, 226f for adjusting right and left sides.

In a method according to one embodiment, as set forth in any of the preceding embodiments, the activation command is directed at a property of an operating table segment and, therefore, the method further comprises presenting on a touch screen an adjustment icon for a property of an operating table segment in an activated mode and/or an adjustment instruction for a property of an operating table segment, said operating table segment being at least one of the following: an operating table top, at least one lamp for an operating table, and at least one camera for an operating table.

In FIG. 2c, the left and right leg segments are jointly adjustable, yet each is provided with a possibility of individual adjustment. With the green action button, for example, the adjustment occurs as directed by an upper green indicator arrow 240a. Thus, the entire leg segment rises as the user presses the green action button. The adjustment does not stop until the user no longer presses the action button. Respectively, with the red action button, the adjustment occurs downwards as directed by a red indicator arrow 240b, whereby the leg segment descends as the user presses the red action button.

Optionally, the leg segment can be made in just a single element, whereby, in the side view 222 of an operating table, the leg segment is naturally presented as a single element and its adjustment takes place as a movement of the entire leg segment up and down in the same way as in the case of a two-part leg segment.

A method according to one embodiment, as set forth in any of the preceding embodiments, further comprises presenting at least one current setting for a property of an activated operating table segment and/or an additional focus icon for a property.

Wishing to adjust the entire leg segment to a lower position as directed by the lower red arrow 240b, the user presses the red action button in phase 145, whereby, in phase 150, the remote controller transmits by way of an RF link an adjustment command to the operating table, on the basis of which the operating table control unit adjusts the operating table's left and right leg segments jointly downwards by some specific number of degrees, which depends on how long the user holds the button down.

In the event that it is only desirable to move the right side of a two-part leg segment, there is activated the adjustment icon 226e, whereby it is presented in an activated mode for example by changing its appearance or coloring, as well as, in connection with the adjustment icon 226e, adjustment instructions similar to the adjustment instructions 240c, 240b for action buttons, for example green and red/orange action buttons, present on the remote controller and intended for the actual right leg adjustment, as well as current leg segment settings in the information space 238. Hence, the adjustment of a leg segment's right leg occurs in a manner similar to the case of an entire leg segment. Adjustment of the left side and the consequences of activating the adjustment icon 226f match those of the right leg.

A method according to one embodiment, as set forth in any of the preceding embodiments, further comprises receiving, by way of the action buttons of a portable device, an adjustment command for a property of an operating table segment activated by an activation command, wherein the activated adjustment icon for an operating table segment's property presents an instruction for an adjustment effected by the action buttons.

In phase 155, once the adjustment command has been sent to the operating table, the effect of adjustment is presented to the user in the touch screen's information space 238 for example as a number of degrees and/or, at least in the upper view 222 of an operating table, graphically as a static position of the activated segment, whereby the user, without seeing the operating table, is capable of visually observing the effect of adjustment and making sure that the adjustment occurred in a desired direction, i.e. downwards. Accordingly, for example in the view 222 of an operating table, the leg segment is shown in a position descended lower than in the previous position. Respectively, if the adjustment has occurred upwards, the leg segment will be presented in a position higher than the previous position. In case of a height adjustment, for example, the effect is depicted as a length measurement and/or, in the lower view 224 of an operating table, graphically as a static position.

A method according to one embodiment, as set forth in any of the preceding embodiments, further comprises presenting on a touch screen graphically the effect of an adjustment command on an operating table.

In case a continuation of the leg segment adjustment is desired in phase 160, the user may continue the leg segment adjustment with action buttons and the method returns to phase 145. On the other hand, if the user wishes to adjust another property of the operating table in phase 165, a return is made to phase 120 for activating the adjustment icon 226b, 226c, 226d, 228a, 228b, 228c, 228d for some other property of the operating table.

On the other hand, if the ser wishes in phase 110 to go back to the start menu, in which it is possible to select the control of for example lamps and cameras, a return is made to phase 110 by pressing the remote controller's power switch, i.e. the HOME key, for a short period, for example less than 2 seconds. Otherwise the method 100 comes to an end in phase 175. Power is switched off of the remote controller by pressing its power switch for example more than two seconds. Respectively, if the remote controller is picked up and moved about, there is an accelerometer which detects the motion and power is returned to the remote controller.

If, in the process of activating a property of the operating table, the method 100 recognizes in phase 130 a predetermined fault condition, the user is informed in phase 135 with a touch screen about the fault condition and is possibly given instructions regarding how to proceed forward from the fault condition. After this, the method returns to phase 120. In FIG. 2d, the user has activated the adjustment icon 226b for moving the position of an operating table top and the activation has produced a fault report, in which the appearance and/or coloring of the adjustment icon 226b has changed to indicate that the adjustment is not possible. One way of implementing the indication is for example that the adjustment icon 226b turns grey. In addition, the user is given instructions to correct the fault condition in such a way that the Trendelenburg icon 226d has turned red and has an indication as to which way the adjustment should be made with the action button, as well as further instructions in the information space 238. The user is now capable of correcting the condition by activating in phase 135 the Trendelenburg icon 226d and by performing the adjustment as per instructions. Alternatively, the user, after receiving a fault report and correction instructions, is able to select some other adjustment icon 226a, 226c, 228a, 228b, 228c, 228d and to attempt a correction by its adjustment.

The control of the at least one lamp and/or the at least one camera of an operating table proceeds in a manner similar to that of the operating table top, i.e. the remote controller and the lamp/camera assembly are paired with each other and the control occurs wirelessly by means of the remote controller's touch screen and action buttons.

When wishing to adjust the settings of lamps and/or cameras, the user selects through the touch screen from the start menu 200 in phase 115 an icon 204 indicating a lamp/camera unit, in response to which there is presented on the touch screen a lamp/camera tab page 250 as shown in FIG. 2e, in which are displayed tab pages 260a, 260b, 260c for three lamps. The number of lamps may vary and the lamp may comprise a camera integrated in association therewith, such as a lamp 1 present on the tab page 260a in this example. Information 262 relating to the assembly of lamp and camera is also found in a top margin of the touch screen. Lamps 2 and 3 present on the tab pages 260b, 260c may also be provided with a camera as necessary.

In a top section of the tab page 260a is also presented a power button 264 for the lamp, which is used for wirelessly switching on the power for the lamp/camera unit, the appearance and/or coloring of the power button 264 changing to indicate that the lamp has been turned on. In addition, the lamp settings can be adjusted with an adjustment icon 266 intended for brightness adjustment and with an adjustment icon 268 intended for beam size adjustment. In a lower position is, on the other hand, a power button 270 for the camera, an adjustment icon 272 intended for zoom adjustment, an autofocus button 274, a fixed focus button 276, and a freeze image button 278 the pressing of which serves to freeze the image but live recording continues in the background.

In the event that the user switches on power for a lamp of the tab page 260a, alongside its adjustment icons 266, 268 appear current settings 280, 282 of the adjustments, as disclosed in FIG. 2f. The same applies also to the camera zoom adjustment icon 272 whose current settings 284 become visible after the user has switched on power for the camera by means of the power button 270 as shown in FIG. 2g. The lamp and the camera may naturally be on also at the same time.

It is further presented in FIG. 2g as to how, after the user has by way of the touch screen selected the lamp brightness adjustment icon 266, alongside the same appear adjustment instructions 284a, 284 for the adjustment of brightness by means of action buttons exactly the same way as in the adjustment of an operating table top. Respectively, the instructions are also shown in connection with the adjustment icons 268, 272 should the user activate those for adjustment. The adjustment for increased brightness occurs by pressing the action button indicated by the adjustment instruction 284a or for decreased brightness with the action button indicated by the adjustment instruction 284b.

In the start menu 200, it is also possible to press the service icon 206 for an access to browse service tab pages of the device, by which it is possible, for example, to use troubleshooting in fault conditions, to test operation of the remote controller or its battery, to view instruction videos intended for the guidance of maintenance measures or images of spare parts, to determine a maintenance schedule for the remote controller, the operating table and/or the lamp/camera unit, and to view the error log. Pressing the settings icon 208 enables for example a selection of employed language, a sleep mode running time, as well as a presentation mode for information displayed on the touch screen, for example presentation modes for length measurements and degrees. I addition, the settings icon 208 provides an access to examine and change settings for the remote controller, the operating table, the lamps and cameras, as well as operation and display settings for the synchronization feature (pairing). Behind the instructions icon 210 can be found, on the other hand, instructions for operating the remote controller, for cleaning, for the adjustment of settings, for emergency situations, for transporting a patient, and for charging batteries. The instructions may come in text, pictures, and/or videos.

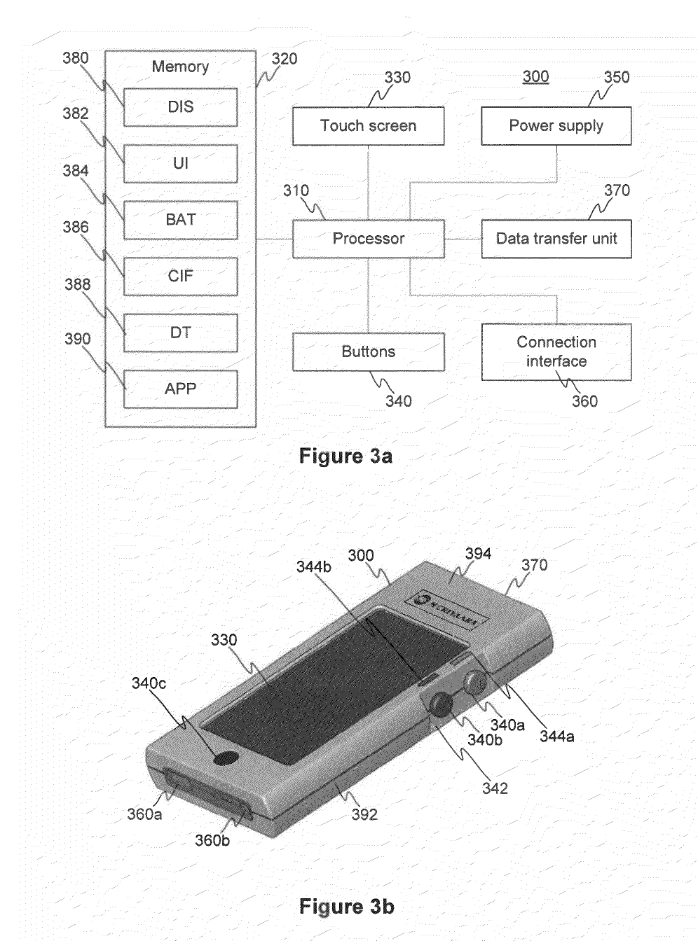

In FIG. 3a there is shown a wireless remote controller 300 for an operating table included in an operating room unit, and/or for its lamp/camera unit, in which are encased one or more processors 310 used for executing instructions defined for example by a user or an application program and for processing data. The device 300 is naturally provided with one or more external or internal memories 320 for storing and saving data, for example instructions. In addition, the device 300 features a resistive or capacitive touch screen 330, physical action buttons 340, comprising for example a power button, i.e. a HOME key, and two adjustment buttons, for example a lithium-ion battery as a power supply 350, one or more connection interfaces 360, for example for a USB cable for software updates, and/or a port for a charging device, as well as a data transfer unit 260, comprising an RF transceiver and an IR transceiver by means of which the remote controller 300 transmits and receives information. The remote controller 300 may further include an accelerometer unit, which is adapted to sense motion of the remote controller 300, on the basis of which it can be repowered.

The memory 320 comprises additionally a program 380 controlling operation of the touch screen, a program 382 intended for the action buttons, a program 384 intended for controlling the power supply, a program 386 intended for controlling the at least one connection interface, at least one program 388 intended for controlling the data transfer unit's RF and IR transceivers, and a program 390 which enables the remote controller 300 to control an operating table and/or its lamp/camera unit.

In a remote controller 300 of one embodiment intended for controlling an operating table, as set forth in any of the preceding embodiments, the computer program 390 stored in its memory 320 is adapted, jointly with at least one processor 310, to enable the remote controller 300 to at least receive an operating table activation command by way of the device's touch screen 330 and to transmit by the data transfer unit 370, for example by an RF transceiver, wirelessly an adjustment command consistent with the activation command to the operating table for controlling the same in accordance with the adjustment command.

In a remote controller 300 according to one embodiment, as set forth in any of the preceding embodiments, the activation command is directed at a property of an operating table segment and, in response to that, there is presented on the touch screen 330 an adjustment icon for a property of an operating table segment in an activated state and/or an adjustment instruction for a property of an operating table segment, said operating table segment being at least one of the following: an operating table top, at least one lamp for an operating table, and at least one camera for an operating table.

In a remote controller 300 according to one embodiment, as set forth in any of the preceding embodiments, there is presented on the touch screen 330 from at least one perspective an operating table top intended to be graphically controlled, as well as an adjustment icon and/or an action icon for at least one property of the operating table top.

In a remote controller 300 according to one embodiment, as set forth in any of the preceding embodiments, there is presented on the touch screen 330 an additional focus icon for at least one current setting and/or property regarding the property of an activated operating table segment.

In a remote controller 300 according to one embodiment, as set forth in any of the preceding embodiments, there is received via the touch screen 330 an adjustment command by way of the action buttons 340 for a property of an operating table segment activated with an activation command, wherein the activated adjustment icon for a property of an operating table segment presents an instruction for the adjustment effected with the action buttons 340.

In a remote controller 300 according to one embodiment, as set forth in any of the preceding embodiments, there is graphically presented on the touch screen the effect of an adjustment command on an operating table.

A computer program 390 according to one embodiment intended for controlling an operating table, which is set forth in any of the preceding embodiments and which is executed with a processor 310, has a reception code for receiving an operating table activation command by way of a touch screen 330 and a transmission code for transmitting an adjustment command consistent with the activation command wirelessly, for example with an RF transceiver 370, to the operating table for controlling the same in accordance with the adjustment command.

In a computer program 390 according to one embodiment, as set forth in any of the preceding embodiments, the activation command is directed at a property of an operating table segment and, in response to that, the computer program 390 is further provided with a presentation code to present on the touch screen 330 an adjustment icon for a property of an operating table segment in an activated state and/or an adjustment instruction for a property of an operating table segment, said operating table segment being at least one of the following: an operating table top, at least one lamp for an operating table, and at least one camera for an operating table.

In a computer program 390 according to one embodiment, as set forth in any of the preceding embodiments, there is further a presentation code to present on the touch screen 330 from at least one perspective an operating table top intended to be graphically controlled, as well as an adjustment icon and/or an action icon for at least one property of the operating table top.

In a computer program 390 according to one embodiment, as set forth in any of the preceding embodiments, there is further a presentation code to present on the touch screen 330 an additional focus icon for at least one current setting and/or property regarding the property of an activated operating table segment.

In a computer program 390 according to one embodiment, as set forth in any of the preceding embodiments, there is further a reception code to receive by way of physical action buttons 340 an adjustment command for a property of an operating table segment activated with an activation command via the touch screen 330, wherein the activated adjustment icon for a property of an operating table segment presents an instruction for the adjustment effected with the action buttons.

In a computer program 390 according to one embodiment, as set forth in any of the preceding embodiments, there is further a presentation code to present on the touch screen 330 graphically the effect of an adjustment command on an operating table.

In a computer program 390 according to one embodiment, as set forth in any of the preceding embodiments, the controlled operating table is included in an operating room unit which may further comprise at least one of the following: at least one lamp unit for an operating table, at least one camera unit for an operating table, and at least one monitor for an operating table.

In a computer program 390 according to one embodiment, as set forth in any of the preceding embodiments, the discussed computer program 390 is a computer program product which comprises a computer-readable data transfer medium provided with a computer program code intended to be executed by a computer.

FIG. 3b shows the appearance of a remote controller 300, which is intended for controlling at least one apparatus, for example an operating table, included in an operating room unit, and which consists of a cover 392 made for example in plastic or aluminum making up a frame for a touch screen 330, for action keys 340a, 340b, 340c made for example in silicone, for connection interfaces 360a, 360b, and for a data transfer unit 370.

In a remote controller 300 according to one embodiment, as set forth in any of the preceding embodiments, the operating table is included in an operating room unit which may further comprise at least one of the following: at least one lamp unit for an operating table, at least one camera unit for an operating table, and at least one monitor for an operating table.

The adjustment buttons 340a, 340b, i.e. up and down buttons, are located for example in a recess 342 on the right side of a remote controller 300 for example about 20 mm in thickness, being protected therein for example from mechanical knocks and attrition. The green up button 340a has its adjustment direction indicated with a direction arrow 344a of the matching color present on a top surface 394 of the remote controller, and the red/orange down button 344b has its adjustment direction shown by a direction arrow 344b of the matching color. The adjustment buttons 340a, 340b are located so as to enable the operation thereof with one hand while wearing latex gloves, both with the right and the left hand. The power/home button 340c, on the other hand, is located on the top surface 394 below the touch screen 330, wherein its top face is flush with the surface 392 of the cover.

The USB port 360a for receiving a USB flash drive containing for example a software update and the charging port 360b for charging a battery 350 with an appropriate charging device are located for example on a bottom side of the remote controller 300. The charging device can be for example a docking station, whereby it is possible to use a remote controller 300 installed therein. The connection interfaces 360a, 360b can be protected with a silicone guard, which is placed on top of the same and which is removed from top of the same as the ports 360a, 360b are used. An IR transceiver included in the data transfer unit 370 is in turn integrated on a top side of the cover 392.

It is possible to integrate a storage hook with the remote control 300 or to use a separate rack for keeping it on a storage rail in the operating room.

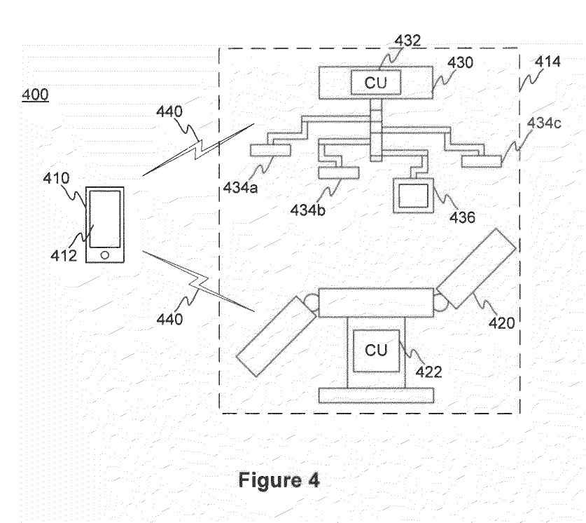

FIG. 4 shows a control system 400, wherein a wireless remote controller 410 is used for controlling an operating table 420 and/or a lamp/camera unit 430 included in an operating room unit.

The remote controller 410 has at least one processor and at least one memory comprising a computer program code, said at least one memory and the computer program code being adapted, jointly with the at least one processor, to enable the remote controller 410 to at least receive by way of its touch screen 412 an activation command for the operating table 420 and/or for the lamp/camera unit 430 and to transmit wirelessly with its data transfer unit, which comprises for example an RF transceiver, an adjustment command consistent with the activation command to the operating table 420 and/or to the lamp/camera unit 430 for controlling the same in accordance with the adjustment command.

The operating table 420 includes a control unit 422, which is provided with at least one processor, at least one memory, and at least one data transfer unit, which comprises at least an RF transceiver and an IR receiver and by means of which it communicates with the remote controller 420 by way of an R link and/or an IR link 440. If necessary, the data transfer unit may also comprise an IR transmitter. The control unit 420 has stored in its memory a computer program, which is adapted to receive control commands which have arrived from the remote controller 410 and on the basis of which it controls the operating table 420, as well as adapted to transmit information to the remote controller 410 regarding the operating table 420. The operating table 420 may also comprise its own control panel and/or a manual controller, whereby it is possible to control the control unit 422 also from the operating table's 420 own control panel and/or from the manual controller. Thus, the control commands having arrived from the control panel and/or from the manual controller cancel the control commands having arrived from the remote controller 410 should the overlapping commands contain discrepancies.

The lamp/camera unit 430 included in the control system 400 features a control unit 432, which has at least one processor, at least one memory unit, and at least one data transfer unit, which comprises at least an RF transceiver and an IR receiver and by means of which it communicates with the remote controller 420 by way of an RF link and/or an IR link 440. If necessary, the data transfer unit may also comprise an IR transmitter. The control unit 432 has stored in its memory a computer program, which is adapted to receive control commands which have arrived from the remote controller 410 and on the basis of which is it controls at least one lamp 434a, 434b, 434c as well as a camera integrated therewith. The lamp 434a, 434b, 434c can also come without an integrated camera. The computer program is also adapted to transmit information to the remote controller 410 regarding the lamps 434a, 434b, 434c and the cameras 420. In case the lamp/camera unit 430 has at least one camera, it will additionally include a monitor 436 for presenting an image communicated by the camera. The lamp/camera unit 430 may also comprise its own control panel and/or a manual controller, whereby it is possible to control the control unit 432 also from the lamp/camera unit's 430 own control panel and/or from the manual controller. Thus, the control commands having arrived from the control panel and/or from the manual controller cancel the control commands having arrived from the remote controller 410 should the overlapping commands contain discrepancies.

The remote controller 410, the operating table 420, and the lamp/camera unit 430 establish a wireless star network, in which the remote controller 410 functions as a hub and the operating table 420 and the lamp/camera unit 430 do not communicate with each other. In addition, the remote controller 410 can be adapted to control monitors, for example their turn-ons and turn-offs, and/or electrical outlets or the like to be controlled by way of an IR link.

In a control system 400 according to one embodiment, as set forth in any of the preceding embodiments, the activation command is directed at a property of a segment included in an operating table 420 and/or in a lamp/camera unit 430 and, in response to that, the remote controller 410 further presents on its touch screen 412 an adjustment icon in an activated state for a property of a segment included in the operating table 420 and/or in the lamp/camera unit 430 and/or an adjustment instruction for a property of a segment included in the operating table 420 and/or in the lamp/camera unit 430.

In a control system 400 according to one embodiment, as set forth in any of the preceding embodiments, the remote controller 410 further presents on its touch screen 412 from at least one perspective an operating table top 420 intended to be graphically controlled, and/or an adjustment icon and/or an action icon for a property of at least one operating table top 420 and/or lamp/camera unit 430.

In a control system 400 according to one embodiment, as set forth in any of the preceding embodiments, the remote controller 410 further presents on the touch screen 412 an additional focus icon for at least one current setting and/or property regarding the property of an activated segment included in the operating table 420 and/or in the lamp/camera unit 430.

In a control system 400 according to one embodiment, as set forth in any of the preceding embodiments, the remote controller 410 further receives by way of the remote controller's 410 action buttons an adjustment command for a property of the segment activated with an activation command and included in the operating table 420 and/or in the lamp/camera unit 430, wherein the activated adjustment icon for a property of a segment included in the operating table 420 and/or in the lamp/camera unit 430 presents an instruction for the adjustment effected on the touch screen 412 with action buttons.

In a control system 400 according to one embodiment, as set forth in any of the preceding embodiments, the remote controller 410 presents on the touch screen 412 graphically the effect of an adjustment command on the operating table 420 and/or on the lamp/camera unit 430.

In a control system 400 according to one embodiment, as set forth in any of the preceding embodiments, the operating table 420 is included in an operating room unit 414, which may comprise at least one of the following: at least one lamp unit 434a, 434b, 434c for an operating table, at least one camera unit 434a, 434b, 434c for an operating table, and at least one monitor 436 for an operating table.

Described above are just a few exemplary embodiments of the invention. The principle according to the invention is naturally modifiable within the scope of protection defined by the claims, regarding for example implementation details and fields of use.

1. A method for controlling an operating table with a portable device, the portable device having a touch screen and an action button for moving an operating table or a segment thereof in any direction, comprising:
receiving an operating table activation command by way of the portable device's touch screen; and
transmitting wirelessly to an operating table an adjustment command, which is consistent with the activation command and received from the action button, for controlling the operating table in accordance with the adjustment command.

2. The method of claim 1, further comprising:
directing the activation command at a property of an operating table segment; and
presenting on the touch screen, in response to the directing step, an adjustment icon in an activated state for a property of an operating table segment and/or an adjustment instruction for a property of an operating table segment, said operating table segment being at least one of the following: an operating table top, at least one lamp for an operating table, and at least one camera for an operating table.

3. The method of claim 1, further comprising presenting on the touch screen from at least one perspective an operating table top intended to be controlled graphically, as well as at least one adjustment icon and/or an action icon for a property of the operating table top.

4. The method of claim 1 further comprising presenting at least one current setting for a property of an activated operating table segment and/or an additional focus icon for the property.

5. The method of claim 2 further comprising receiving by way of the portable device's action buttons an adjustment command for a property of an operating table segment activated with an activation command, wherein the activated adjustment icon for a property of an operating table segment presents an instruction for the adjustment effected with the action buttons.

6. The method of claim 1 further comprising presenting on a touch screen graphically the effect of an adjustment command on an operating table.

7. The method of claim 1, wherein the operating table is included in an operating room unit, further comprising at least one of the following:
providing at least one lamp unit for an operating table;
providing at least one camera unit for an operating table; and
providing at least one monitor for an operating table.

8. A system for controlling an operating table, comprising:
an operating table; and
a portable device having a touch screen, wherein the touch screen has an action button for moving an operating table or a segment thereof in any direction;
the touch screen further having an operating table activation command icon; and
wherein the operating table is controllable by the portable device via a wirelessly transmitted adjustment command wherein the adjustment command is consistent with the activation command inputted on the touch screen and received from the action button.

9. The system of claim 8, wherein the touch screen has an operating table segment icon further comprises at least one of the group consisting of an operating table top, at least one lamp for an operating table, and at least one camera for an operating table wherein the activation command is directed at a property of an operating table segment; and the touch screen further has an adjustment icon appearing in response to the activation command, wherein the adjustment icon is in an activated state for a property of an operating table segment and/or an adjustment instruction for a property of an operating table segment.

10. The system of claim 8, wherein the touch screen further comprises at least one of the group consisting of:
an image of least one perspective of an operating table top to be controlled graphically;
at least one adjustment icon; and
an action icon for a property of the operating table top.

11. The system of claim 8 wherein the touch screen further comprises at least one of the group consisting of:
at least one current setting message or icon for a property of an activated operating table segment;
and an additional focus icon for the property.

12. The system of claim 9 wherein the portable device's action buttons receive an adjustment command for a property of an operating table segment activated with an activation command, and wherein the activated adjustment icon for a property of an operating table segment presents an instruction for the adjustment effected with the action buttons.

13. The system of claim 8 wherein the touch screen comprises a graphical icon, wherein the graphical icon presents the effect of an adjustment command on an operating table.

14. The system of claim 8, further comprising an operating room unit having the operating table, and further comprises at least one of the group consisting of at least one lamp unit for an operating table, at least one camera unit for an operating table, and at least one monitor for an operating table.

15. A device for controlling an operating table, comprising:
a portable device having a touch screen and an action button for moving an operating table or a segment thereof in any direction;
the touch screen having an operating table activation command icon; and
an operating table controlled by an adjustment command transmitted wirelessly, the adjustment command consistent with the activation command and received from the action button.

16. The device of claim 15, wherein the touch screen further comprises:
an operating table segment icon, said operating table segment icon being at least one of the following: an operating table top icon, at least one lamp icon for an operating table, and at least one camera icon for an operating table wherein the activation command is directed at a property of an operating table segment; and
an adjustment icon on the touch screen in response to the activation command, in an activated state for a property of an operating table segment and/or an adjustment instruction.

17. The device of claim 15, wherein the touch screen presents at least one of the group of:
at least one view of an operating table top figure to be controlled graphically;
at least one adjustment icon and/or an action icon for a property of the operating table top;
a graphical representation of the effect of an adjustment command on an operating table;
at least one current setting message or icon presented for a property of an activated operating table segment and/or an additional focus icon for the property.

18. The device of claim 16 wherein the portable device's touch screen's action buttons receive an adjustment command for a property of an operating table segment activated with an activation command, wherein the activated adjustment icon for a property of an operating table segment presents an instruction for the adjustment effected with the action buttons.

19. The device of claim 15, further comprising an operating room unit having the operating table, and further comprises at least one of the group consisting of at least one lamp unit for an operating table, at least one camera unit for an operating table, and at least one monitor for an operating table.
